(19) United States
(12) Patent Application Publication
(10) Pub. No.: US 2006/0233695 A1
(43) Pub. Date: Oct. 19, 2006

(54) Process for the production of hydrogen peroxide from hydrogen and oxygen

(75) Inventors: Adeniyi Lawal, Livingston, NJ (US); Emmanuel A. Dada, Bensalem, PA (US); Woo Young Lee, Ridgewood, NJ (US); Henry Pfeffer, Mercerville, NJ (US)

Correspondence Address: DOCKET ADMINISTRATOR;LOWENSTEIN SANDLER PC, 65 LIVINGSTON AVENUE, ROSELAND, NJ, 07068, US

(73) Assignees: Stevens Institute of Technology; FMC Corporation

(21) Appl. No.: 11/406,021

(22) Filed: Apr. 18, 2006

Related U.S. Application Data
(60) Provisional application No. 60/672,409, filed on Apr. 18, 2005.

(51) Int. Cl. C01B 15/029

(52) U.S. Cl. 423/584; 502/339

(57) ABSTRACT

The present invention provides a process for the production of hydrogen peroxide by direct catalytic reaction of hydrogen and oxygen that uses as a catalyst, a platinum group metal on an acidified support. The present invention also provides a sol-gel catalyst for use in the process and a process for the preparation of the catalyst.

### CROSS-REFERENCE TO RELATED APPLICATION

This application claims priority benefit of U.S. Provisional Application Ser. No. 60/672,409 filed Apr. 18, 2005, which is hereby incorporated by reference in its entirety.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. DE-FC07-02ID 14427, CFDA #81.086 awarded by U.S. Department of Energy (DOE).

### FIELD OF THE INVENTION

The present invention relates to an improved process for producing hydrogen peroxide (H₂O₂) directly from hydrogen and oxygen by a direct catalytic reaction of feed streams containing hydrogen and oxygen, which uses a catalyst comprising a platinum group metal on an acidified support.

### BACKGROUND OF THE INVENTION

Hydrogen peroxide has diverse applications. Its current use ranges from pulp and paper bleaching to health care. In water purification, it is considered as an environmentally friendly alternative to chlorine. It is used in the synthesis of various oxychemicals because of its high selectivity and effectiveness as an oxidizing agent. The annual U.S. production of H₂O₂ is 1.7 billion pounds (lbs.), which represents roughly 30% of the total world output of 5.9 billion lbs. This market is expected to grow steadily at about 4 to about 6% annually.

Hydrogen peroxide is commercially manufactured based on the anthraquinone (AO) process. The processing conditions are typically a pressure of about 50 psig to about 100 psig (pound(s) per square inch gauge), a temperature range of about 30° C. to about 70° C., and a Pd/Al₂O₃ catalyst. As used herein, the term “catalyst” refers to a substance that initiates or increases the rate of a reaction and lowers the activation energy required for the reaction without being consumed itself. The use of the AO process has some major considerations and drawbacks. Because of the many operations required, the commercial plants performing the AO process are large and centralized. The centralized AO process is economically viable when the H₂O₂ is produced at about 70 wt % concentration through an energy intensive distillation stage. End users have increasingly become interested in the concept of on-demand H₂O₂ generation at their sites to reduce transportation, storage, and “concentration dilution” costs. The phrase “concentration dilution,” as used herein, refers to diluting a concentrated substance to diminish or lessen its strength. Hydrogen peroxide commercial applications utilize aqueous solutions that cover a wide range of concentrations, typically from about 5 wt % to about 30 wt %. Hence, the about 70 wt % H₂O₂ concentration produced by the AO process usually is diluted at the site of an end user for storage and subsequent use, rendering the current production, transportation, and distribution systems expensive and inefficient. The AO process also requires solvent processing, gas recycling and treatment, and product purification steps. The direct combination of molecular hydrogen (H₂) and molecular oxygen (O₂) scheme is simpler and more energy efficient than the AO process. It therefore provides a cost effective alternative to the AO process suitable for on-site production of hydrogen peroxide.

The direct combination of a H₂ gas stream and an O₂-containing gas stream in the presence of a catalyst with water as a solution medium has been explored using macroscale reactor technology. As used herein, the phrase “macroscale reactor technology” refers to a large reactor design where the reactor internal transverse dimensions are much larger than those of a microreactor, e.g., greater than about one millimeter. Such direct synthesis processes for the production of H₂O₂ have not been commercially feasible due to safety issues, a high pressure operation requirement, and low catalyst activity and selectivity. For example, U.S. Pat. No. 5,194, 242 to Paoli discloses a pilot scale production of H₂O₂ from H₂ and O₂ using a pipeline reactor to establish a reaction zone for the reaction of these gases within an acidic aqueous solution. The operating conditions, which include a pressure requirement of 1000 psia (pound(s) per square inch absolute), are selected such that the H₂ concentration in the liquid phase exceeds the explosive limit where explosion is not expected to occur, but the H₂ concentration is below the explosive limit in the vapor phase, a phase which is susceptible to explosion. In U.S. Pat. No. 5,641,467, Huckins discloses a similar reactor configuration, but with multiple alternating injection points of H₂ and O₂; the recommended pressure for this process is 3000 psia.

The addition of acid (often sulfuric), to improve the yield (by mitigating the decomposition of H₂O₂) and a trace amount of halide ions (as a catalyst promoter) imposes constraints on material selection for reactor construction due to the corrosive nature of these additives. For example, in U.S. Pat. No. 5,500,202, Germain et al. disclose a trickle bed reactor concept where H₂ and O₂ are reacted directly in the gaseous state at the surface of a solid catalyst that fills the reactor. The aqueous solution that contains sulfuric acid and a trace amount of halogen ions and the reacting gases are caused to trickle concurrently. Germain et al. claim hydrogen peroxide concentration as high as 5 g H₂O₂/100 g of solution, which is better than the 0.07 g H₂O₂/100 g of solution Paoli discloses in U.S. Pat. No.5,194, 242. In U.S. Pat. No.5,236,692, Nagashima et al. discloses a method for producing a high concentration of H₂O₂ by reacting O₂ and H₂ directly in a reaction medium containing a promoter, such as a halogen-containing compound, and using a platinum group metal acidified supported on a solid acid carrier or a solid super acid carrier.

U.S. Pat. No. 5,378,450 to Tomita discloses a process for producing H₂O₂ by reacting O₂ and H₂ in a reaction medium using a tin-modified platinum group metal supported on a carrier catalyst, where a halogen and acid reaction medium is unnecessary but the H₂O₂ yield is low. Zhou et al. disclose in U.S. Pat. No. 6,168,775 the direct catalytic production of H₂O₂ from an O₂-containing gas stream and H₂ using a catalyst made by depositing phase-controlled crystals of a noble metal on a carbon support, resulting in improved catalyst activity and selectivity. Exemplified noble metals disclosed by Zhou et al. include palladium (Pd), platinum (Pt), gold (Au), iridium (Ir), osmium (Os), rhodium (Rh), and ruthenium (Ru). The term “noble metal” generally refers to a chemically inactive metal that is resistant to corrosion or oxidation. U.S. Pat. No. 6,576,214 (Zhou et al.) discloses a similar process for direct production of H₂O₂ by contacting hydrogen and oxygen with a supported noble metal phase-controlled catalyst and a suitable organic liquid solvent.

Macroscale reactor technology for the production of H₂O₂ can have a number of serious drawbacks. When H₂ and O₂ are directly combined, the mixture becomes flammable and even explosive when the H₂ concentration is between about 5 volume percent (vol %) and about 96 vol % for hydrogen/oxygen mixture or between about 5 vol % and about 74 vol % for hydrogen/air mixture. In addition, at high H₂ concentrations, macroreactors often are not capable of removing the excessive heat generated by this reaction effectively. A high recirculation rate by a pump therefore is required, which imposes a high-energy penalty, i.e., more energy is required to safely and effectively perform a macroscale-reactor process, resulting in higher costs and lower efficiency when using the process. Often in macroreactors, at low H₂ concentrations, the rate of H₂ diffusion into the liquid phase is very low; the reaction becomes mass transfer limited and extremely slow, thus, necessitating the use of hazardous high-pressure conditions in the range of about 800 psia to about 2000 psia. The high pressure and thus, high-energy requirements, render the direct combination process uneconomical when the design is implemented with macroscale reactor technology. In order to reduce the operating pressure, the solubility of H₂/O₂ in water can be improved by using chemical additives, but this would necessitate down-stream post treatment of the product H₂O₂ to remove these additives before use of the product H₂O₂, and, as previously mentioned, some of the additives may pose serious corrosion and contamination problems, which can deleteriously affect catalyst performance.

For the direct combination approach to become energy efficient and economically attractive, a radically different approach featuring safe, high-yield and low-pressure operating conditions is needed. Microchannel reactors, by virtue of their small (sub-millimeter) transverse dimensions, possess extremely high surface to volume ratios (about 4×10⁴ m²/m³), and consequently, exhibit enhanced heat and mass transfer rates. Heat and mass transfer coefficients that are at least one order of magnitude higher than obtained in conventional reactors have been reported in microchannel reactors. Highly exothermic reactions, such as the direct combination reaction, can be carried out safely with a high hydrogen concentration (in the regime that would be explosive in a macro-scale conventional reactor) because the width of microreactor channels is smaller than the quenching distance of hydrogen and oxygen radicals. In other words, much higher temperatures and pressures are required to start an explosion in a microchannel than in a macrochannel. In addition, the significant reduction of transverse heat transfer resistance enables better reactor temperature control, which leads to improved reactor conversion and productivity (space-time yield (STY)). The reduction of mass transfer resistance enables the realization of fast, close to intrinsic, kinetics with concomitant improved reactor productivity at considerably lower pressure than often is achievable in macro-reactors. Controlled oxidation of H₂ by O₂ without diluent gas has been demonstrated in microreactors without explosion by Janicke et al. (see e.g., J. Catalysis 191: 282-93 (2000)). Thus, the microchannel reactor approach provides a unique opportunity for realizing the direct combination of H₂ and O₂ in an otherwise explosive concentration regime while enabling low-pressure, improved process control and energy efficiency, and safe reactor operation.

Several patents and articles disclose microchannel reactor technology. For example, U.S. Pat. No. 6,494,614 (Bennett et al.) discloses a microchannel device structure and a method of making the device, while Janicke et al. disclose the microstructured reactor/heat exchanger designed and built by the Karlsruhe Research Center (see supra). Also, Jensen reviews the role of reaction engineering in the development of microreaction technology along with new approaches to scale up based upon replication of microchemical devices (Chem. Eng. Sci. 56: 293-303 (2001)). U.S. Pat. No. 5,811,062 (Wegeng et al.) discloses how macroscale unit processes are performed by microscale components in a microcomponent sheet architecture, and Inoue et al. (Microstructured Devices for Process Intensification: Proc. 7^{th} Intl. Conf. Microreaction Tech., Lausanne, Switzerland 44-8 (Sep. 7-10, 2003)) disclose the use of very high pressure that will make the process highly energy intensive, unlike the present invention, which uses low pressure.

The present invention uses the advantages of microreactors and the simplicity of appropriately increasing in the number of micro-scale elements operating in parallel achieved by stacking/bundling up a plurality of bundled/stacked microchannel plates with multi-channels for a direct combination process for the production of H₂O₂, which has low operating pressure, and thus, safe reactor operating conditions, and better process control and energy efficiency.

Supported catalysts, like those used in the production of H₂O₂, often are prepared using a wet (direct) impregnation method, which has a number of disadvantages in comparison to the sol-gel methods of the present invention. For example, a major problem with the wet impregnation method is the difficulty of achieving homogeneous states of dispersion of the active metal on the support. A sol-gel method of the present invention, on the other hand, provides a more efficient way of preparing supported metal catalysts.

The strong anchoring between the active metal and the support of a sol-gel-made catalyst results in, for example, uniform dispersion, increased specific surface area of the active metal in the support, higher homogeneity, and improved thermal stability of the supported catalysts. This anchoring technique has been demonstrated to be successful for anchoring various metals, like Ni, Pd and Pt, on different supports (Yermakov, Yu. I., Catal. Rev., 13: 77 (1976), Yermakov, Yu. I. and Kuznetzov, B. N., Kinet. Catal., 18:1167 (1977), Yermakov, Yu. I. and Kuznetzov, B. N., J. Mol. Catal. A: Chemical, 9: 13 (1980)); the most common among the supports being Al₂O₃ and SiO₂. Because of the advantages of the sol-gel process, researchers in the past have used this technique for preparing catalysts for different reactions (see, e.g., Lopez, T. et al., J. Catal, 138: 463-473 (1992), Pecchi, G. et al., J. Catal., 179: 309-314, (1998), Zou, W. and Gonzalez, R. D., Appl. Catal A: General, 126: 351-364 (1995)). Generally, the sol-gel process can have a higher degree of control over catalyst preparation than can be achieved with the wet impregnation method by controlling different parameters involved in the synthesis procedure, such as, for example, the precursor ratio, calcination and reduction temperatures, and gelation time, amongst others. By changing these variables, it is possible to tailor the characteristics of the catalyst to the reaction system. For example, the pore structure (e.g., surface area, pore volume, and pore size distribution) of the catalyst can be tailored by controlling a sol-gel parameter such as pH, and thus, its effect on the properties of silica. When conducted under acidic conditions in the sol-gel process, hydrolysis occurs at a faster rate than condensation, and the resulting gel is weakly branched. Condensation is accelerated relative to hydrolysis with increasing pH. Thus, a base-catalyzed gel is highly branched and contains colloidal aggregates. Because of the different extent of branching, acid-catalyzed gels mostly contain micropores (about <2 nm pores) whereas base-catalyzed gels mostly contain mesopores (about 2 to about 50 nm pores).

Strong acids are known to be active catalysts for a number of reactions including, for example, isomerisation, alkylation and oxidation reactions. Strong acids are defined as acids that are stronger than 100% sulfuric acid for Bronsted acids, and stronger than anhydrous aluminum trichloride (AlCl₃) in the case of Lewis acids (Olah, G. A., Prakash, G. K. S. and Sommer, J., Superacids, New York: John Wiley and Sons (1985) (hereinafter, “Olah et al.”). Liquid strong acids, such as fluorosulfonic acid-antimony pentafluoride (HSO₃F/SbF₅; often referred to as “magic acid”), have been known since the 1920s, but solid strong acids have been investigated only recently (see e.g., Olah et al.; Thomas, J. M., Sci. Am., 82 (1992)). For example, zirconia, silica and other acidic materials have started to find increasing application in heterogeneous catalysis both as support and as catalyst. The acidic sites of these supports can be enhanced further by addition of a co-acid (meaning a second additional acidic substance), such as, for example, sulfuric acid, hydrochloric acid, hydrogen cyanide, phosphoric acid, hydrogen bromide, hydrogen fluoride, nitric acid, hydrogen iodide, and the like, or by addition of an acidifying agent (meaning a substance that renders another substance acidic or acid-like), such as, for example, ammonium sulfate. For example, sulfation of zirconia using either sulfuric acid or other forms of sulfate can make the surface of zirconia strongly acidic or even superacidic (Zhuang, Q. and Miller J. M., Can. J. Chem., 79,: 1220-1223 (2001)); sulfated zirconia serves as an important catalyst for the fuel and energy industry. Sulfuric acid is used more often for sulfation of zirconia than other forms of sulfate. Tanabe, K. et al., Crit. Rev. Surf. Chem., 1:1 (1990)), demonstrating that different sources of the sulfate ion gave different results, observed that sulfated catalysts prepared using ammonium sulfate reduce the activation energy by a smaller amount than those prepared using sulfuric acid (Tanabe, K., et al., Proc. 8^{th} Intern. Congr. Catalysis, Berlin, pp. 601-609 (1985)).

In the preparation of H₂O₂ according to the present invention, increasing the acidity of the support of the catalyst used in the direct combination method of the present invention is important because, for example, (1) it helps in preventing the decomposition of H₂O₂, (2) it increases the surface area of the catalyst by increasing the porosity of the support, and (3) the high acidity of the support makes it a strong oxidizing agent so that oxidizing centers of the support transfer a positive charge to the active metal (e.g., Pd→Pd^{δ+} or Pd⁺), which is important for H₂O₂ formation. Meanwhile, Choudhary, V. R. et al. have demonstrated that the activity of a basic support can be increased by fluorination or chlorination, thus making it more selective for H₂O₂ formation (J. Mol. Catal. A: Chemical, 181: 143-149 (2002)). Palladium supported on chlorinated or fluorinated γ-Al₂O₃ was more selective for H₂O₂ formation than palladium supported on un-fluorinated γ-Al₂O₃. For palladium supported on ZrO₂ catalyst, sulfation of the support helped to increase the selectivity for H₂O₂ formation more than with fluorination of the support. Therefore, depending upon the catalytic support, sulfation, florination, chlorination, or in general, acidification, can be used to promote the formation of H₂O₂.

Wet impregnation methods, which involve dispersion of the pre-dried support in a known concentration of acid precursor (see e.g., Wilson, K., et al., “New Catalytic Materials for Clean Technology: Structure-Reactivity Relationships in Mesoporous Solid Acid Catalysts” In Zhou, B., et al. (eds.), Nanotechnology in Catalysis, 1^{st} ed. (2003) Vol. I (pp. 293-312) New York: Springer)) for preparation of acidified supports, are relatively simpler (e.g., involving fewer steps) than the sol-gel method.

As was the case with the non-acidified catalysts, the sol-gel method offers a number of advantages over the wet impregnation method even with the acidified supports. The wet impregnation method offers limited flexibility in active site density, whereas because the sol-gel method offers superior control over composition, it has the potential to produce catalysts with a higher active site density and varying acid strengths (Wilson, K, et al., supra). As used herein, the phrase “active site density” refers to the number of available positions for bonding and/or interaction within a given area. Irrespective of the method used in preparing acidified catalysts, the acidified catalysts show increased activity and enhanced surface area after calcining at elevated temperatures (i.e., temperatures higher than temperatures used for drying the acidified catalysts, such as about 300° C. to about 500° C.). However, at higher temperatures (about >500° C.), the acidity on the surface of the catalyst may be lost and the surface area of the catalyst decreases rapidly with increased calcination temperature.

Further, it has been demonstrated that the surface area and pore volume of the sulfated ZrO₂—SiO₂ catalyst prepared by the sol-gel method was higher than the corresponding unsulfated catalyst, whereas the surface area and pore volume of the sulfated ZrO₂—SiO₂ catalyst prepared by the wet impregnation method was less than the corresponding unsulfated catalyst (Zhuang, Q. and Miller J. M., Can. J. Chem., 79: 1220-1223 (2001)). Zhuang and Miller also obtained optimum sulfate loading in the sulfated sol-gel catalyst to obtain the maximum catalyst activity, which was about 14 molar percent (mol %) (in the solid catalyst) for the dehydration of isopropanol.

Using the advantages of the sol-gel methodology of producing catalysts, the present invention is directed to a novel acidified catalyst and the production thereof, which can be used in the production of H₂O₂. In the production of H₂O₂, the catalyst of the present invention can be used in macroreactor systems and in the direct combination method of the present invention, which uses microreactor technology.

### SUMMARY OF THE INVENTION

The present invention provides a process for the production of hydrogen peroxide by a direct combination of hydrogen and oxygen, the process comprising the steps:
a. reacting a combination of hydrogen-containing gas stream and oxygen-containing gas stream on a catalyst in the presence of a solvent;
b. maintaining (a) under low pressure; and
c. conducting (a)-(b) in a microreactor system.
   In some embodiments, the catalyst of the process for the production of hydrogen peroxide by a direct combination of hydrogen and oxygen comprises at least one platinum group metal on an acidified support.

In some embodiments of the process for the production of hydrogen peroxide by a direct combination of hydrogen and oxygen, the reacting step (a) occurs in the presence of an acid in the solvent. In some embodiments of the process, the reacting step (a) occurs in the presence of a halogen or halide in the solvent. In some embodiments of the process, the reacting step (a) is conducted in the absence of an acid and in the presence of a halogen or a halide in the solvent; in some embodiments, the reacting step (a) is conducted in the presence of an acid in the solvent. In some embodiments of the process, the reacting step (a) is conducted in the presence of a halogen or a halide in the solvent. In some embodiments of the process, the reacting step (a) is further conducted in the presence of an acid in the solvent. In some embodiments of the process, the reacting in step (a) is continuous.

In some embodiments of the process for the production of hydrogen peroxide by a direct combination of hydrogen and oxygen, the acid comprises from about 1 ppm to about 5×10⁴ ppm of the solvent. In some embodiments, the acid of the process for the production of hydrogen peroxide by a direct combination of hydrogen and oxygen comprises H₂SO₄, H₃PO₄, HCl, HCN, HNO₃, HBr or HI.

In some embodiments of the process for the production of hydrogen peroxide by a direct combination of hydrogen and oxygen, the halogen is Br, Cl, I, F or At. In some embodiments, the halogen Br.

In some embodiments of the process for the production of hydrogen peroxide by a direct combination of hydrogen and oxygen, the halide comprises a metal halide; in some embodiments, the metal halide is NaBr, KBr, KCl or KI. In some embodiments of the process for the production of hydrogen peroxide by a direct combination of hydrogen and oxygen, the metal halide comprises an amount from about 1 ppm to about 50 ppm; in some embodiments, an the amount of metal halide comprises about 10 ppm.

In some embodiments the reactor system of the process for the production of hydrogen peroxide by a direct combination of hydrogen and oxygen has a temperature from about 20° C. to about 60° C. In some embodiments, the reactor system has a temperature from about 25° C. to about 55° C.; in some embodiments, the temperature is from about 40° C. to about 50° C.

In some embodiments of the process for the production of hydrogen peroxide by a direct combination of hydrogen and oxygen, step (b) further comprises having an inlet pressure from about 50 psig to about 500 psig and an outlet pressure of about 0 psig to about 500 psi.

In some embodiments of the process for the production of hydrogen peroxide by a direct combination of hydrogen and oxygen, the solvent is aqueous. In some embodiments, the solvent comprises water; in some embodiments, the solvent is organic. In some embodiments, the solvent of the process for the production of hydrogen peroxide by a direct combination of hydrogen and oxygen methanol, ethanol, acetone, toluene, hexane, acetonitrile, 1-propanol, 2-propanol, acetic acid, isopropanol, triethanolamine, or a combination thereof.

In some embodiments of the process for the production of hydrogen peroxide by a direct combination of hydrogen and oxygen, the catalyst in step (a) is prepared by a sol-gel process. In some embodiments, the platinum group metal of the catalyst in step (a) comprises palladium. In some embodiments, the catalyst in step (a) further comprises a second platinum group metal. In some embodiments, the second platinum group metal comprises iridium, osmium, platinum, rhodium or ruthenium.

In some embodiments, the acidified support of the catalyst of the process for the production of hydrogen peroxide by a direct combination of hydrogen and oxygen comprises a silica compound, a zirconia compound, an alumina compound, or a combination thereof. In some embodiments, the acidified support comprises a silica compound. In some embodiments, the acidified support is acidified by a co-acid. In some embodiments, the co-acid comprises sulfuric acid, hydrochloric acid, hydrogen cyanide, phosphoric acid, hydrogen bromide, hydrogen fluoride, nitric acid or hydrogen iodide. In some embodiments, acidified support is acidified by an acidifying agent; in some embodiments, the acidifying agent comprises ammonium sulfate.

In some embodiments, the metal(s) of the process for the production of hydrogen peroxide by a direct combination of hydrogen and oxygen comprises from about 0.1 wt % to about 2 wt % of the catalyst; from about 0.1 wt % to about 6 wt % of the catalyst; or from about 0.1 wt % to about 5 wt % of the catalyst.

In some embodiments, the process for the production of hydrogen peroxide by a direct combination of hydrogen and oxygen further comprises the step of packing the catalyst inside the reactor system. In some embodiments, the catalyst is packed inside the reactor in an amount comprising from about 10 gm/liter reactor volume to about 1000 gm/liter reactor volume. In some embodiments, the process for the production of hydrogen peroxide by a direct combination of hydrogen and oxygen further comprises the step of depositing the catalyst onto an internal wall of the reactor as a thin-film. In some embodiments, the thin-film of catalyst comprises a thickness of about 1 μm to about 20 μm.

In some embodiments, the process for the production of hydrogen peroxide by a direct combination of hydrogen and oxygen involves the hydrogen and oxygen in a proportion that comprises a flammable regime, explosive regime or both. In some embodiments of the process, the proportion of hydrogen and oxygen comprises from about 5 vol % to about 96 vol % hydrogen in oxygen or about 5vol % to about 74 vol % hydrogen in air. In some embodiments of the process, the hydrogen and oxygen are in a proportion comprising about a 1:1 molar ratio.

In some embodiments, the process for the production of hydrogen peroxide by a direct combination of hydrogen and oxygen comprises an effluent leaving the reactor that is non-explosive. In some embodiments of the process, the effluent is diluted with nitrogen. In some such embodiments, the nitrogen is in an amount of about 100 sccm.

In some embodiments, the hydrogen of the process for the production of hydrogen peroxide by a direct combination of hydrogen and oxygen comprises a hydrogen and air mixture. In some such embodiments, the mixture comprises about 1 vol % to about 10 vol % hydrogen in air; the mixture comprises about 2 vol % to about 4 vol % hydrogen in air; or the mixture comprises about 2.89 vol % hydrogen in air. In some embodiments, the hydrogen of the process for the production of hydrogen peroxide by a direct combination of hydrogen and oxygen comprises pure molecular hydrogen.

In some embodiments, the oxygen of the process for the production of hydrogen peroxide by a direct combination of hydrogen and oxygen comprises air; in some embodiments, the oxygen comprises pure molecular oxygen.

In some embodiments of the process for the production of hydrogen peroxide by a direct combination of hydrogen and oxygen, the reactor system comprises a fixed bed reactor.

The present invention further provides a sol-gel-produced catalyst comprising one or more platinum group metals and an acidified support. In some embodiments, the platinum group metal of the sol-gel-produced catalyst of the present invention comprises palladium. In some embodiments, the sol-gel produced catalyst of the present invention further comprises a second platinum group metal. In some such embodiments, the second platinum group metal comprises iridium, osmium, platinum, rhodium or ruthenium.

In some embodiments, the acidified support of the sol-gel-produced catalyst of the present invention comprises a silica compound, a zirconia compound, an alumina compound, or a combination thereof. In some embodiments of the catalyst, the acidified support comprises a silica compound. In some embodiments of the catalyst, the acidified support is acidified by a co-acid. In some such embodiments, the co-acid comprises sulfuric acid, hydrochloric acid, hydrogen cyanide, phosphoric acid, hydrogen bromide, hydrogen fluoride, nitric acid or hydrogen iodide. In some embodiments of the catalyst, the acidified support is acidified by an acidifying agent; in some embodiments, the acidifying agent comprises ammonium sulfate.

In some embodiments, the metal(s) of the sol-gel-produced catalyst comprises from about 0.1 wt % to about 2 wt % of the catalyst; from about 0.1 wt % to about 6 wt % of the catalyst; or from about 0.1 wt % to about 5 wt % of the catalyst.

In some embodiments, the so-gel-produced catalyst of the present invention is used for production of hydrogen peroxide in a macroreactor. In some embodiments, the so-gel-produced catalyst of the present invention is used for production of hydrogen peroxide in a microreactor.

The present invention further provides a process for preparing a catalyst, the process comprising the steps of:
a. preparing a gel of an acidified support by a sol-gel process that comprises the steps of:
   i. forming a sol comprising a precursor material of the support and a co-acid;
   ii. casting the sol into a mold to form a gel;
   iii. adding a platinum group metal at the gelation step of (ii); and
   iv. optionally, adding one or more additional platinum group metals; and
b. drying the gel of (a);
c. calcining the dried gel of (b); and
d. reducing the calcined gel of (c).

In some embodiments, the drying of step (b) of the process of the present invention for preparing a catalyst occurs at a temperature from about 100° C. to about 200° C.; in some embodiments, the drying of step (b) occurs at a temperature from about 110° C. to about 150° C.; or in some embodiments, the drying of step (b) occurs at a temperature of about 110° C.

In some embodiments, the process of the present invention for preparing a catalyst comprises the calcining of step (c) occurring at a temperature from about 300° C. to about 500° C.; or in some embodiments, the calcining of step (c) occurs at a temperature of about 300° C.

In some embodiments, the process of the present invention for preparing a catalyst comprises the reducing of step (d) occurring at a temperature from about 300° C. to about 500° C.; or in some embodiments, reducing of step (d) occurs at a temperature of about 400° C.

In some embodiments, the process of the present invention for preparing a catalyst comprises the precursor material of the support and the co-acid having a molar ratio of about 0.01 to about 10; or in some embodiments, the precursor material of the support and the co-acid having a molar ratio of about 0.05 to about 5. In some embodiments of the process of the present invention for preparing a catalyst, the precursor material of the support comprises tetraethyoxysilane. In some embodiments of the process of the present invention for preparing a catalyst, the co-acid comprises sulfuric acid, hydrochloric acid, hydrogen cyanide, phosphoric acid, hydrogen bromide, hydrogen fluoride, nitric acid or hydrogen iodide.

In some embodiments, the process of the present invention for preparing a catalyst involves step (a) comprising a solvent. In some such embodiments, the solvent comprises ethanol. In some embodiments of the process of the present invention for preparing a catalyst, the precursor material of the support and the solvent (e.g., ethanol) have a molar ratio of about 0.1 to about 10.

The present invention further provides a network for use in the production of hydrogen peroxide according to a process for the production of hydrogen peroxide by a direct combination of hydrogen and oxygen, the process comprising the steps:
a. reacting a combination of hydrogen-containing gas stream and oxygen-containing gas stream on a catalyst in the presence of a solvent;
b. maintaining (a) under low pressure; and
c. conducting (a)-(b) in a microreactor system.
   In some embodiments, the network of the present invention comprises a check valve, a flame arrester, an excess flow value and a hydrogen detector. In some embodiments, the network of the present invention further comprises a back pressure regulator, a mass flow controller, a pressure indicator, a pressure regulating value, and a thick-walled metallic enclosure for a gas mixer.

### BRIEF DESCRIPTION OF THE DRAWING

FIG. 1 diagrams a network for directly combining hydrogen and oxygen for producing hydrogen peroxide according to the invention.

### DETAILED DESCRIPTION OF THE INVENTION

In some embodiments, the present invention provides a process for the production of hydrogen peroxide by the direct catalytic reaction of gaseous hydrogen and gaseous oxygen feed stream(s) and a feed stream containing a solvent (i.e., a liquid stream), where the catalyst comprises one or more platinum group metals on an acidified support. In some embodiments, the process of the present invention comprises optionally, reacting the hydrogen and oxygen on a catalyst comprising an acidified support and in the presence of an acid dissolved in a solvent (i.e., a liquid stream in which acid is added, e.g., to further improve the reactor performance). In some embodiments, the process comprises optionally, reacting the hydrogen and oxygen on a catalyst in the presence of a halogen or halide dissolved in a solvent. In some embodiments, the process of the present invention comprises maintaining the reaction at a low pressure and conducting the reaction in a reactor system such as e.g., a microreactor. In some embodiments, the catalysts of the process of the present invention can be either in the form of a column, particulates, pellets, granules or powder packed into the reactor or deposited as a thin film on the wall of the reactor. In some embodiments, the process of the present invention comprises a gas and liquid mixture that is directly in contact with the catalysts of the present invention. In some embodiments, the process of the present invention provides a high-energy efficiency, wherein the high-energy efficiency can be achieved by either eliminating the use of a compressor for the gaseous feed streams or, if a compressor is used, reducing the energy consumption of the compressor because of a low operating pressure.

As used herein, the term, “feed stream” refers to the continuous supply or introduction of a substance, such as hydrogen, into a system, such as a reactor. As used herein, the term “solvent” refers to the most abundant component in a homogeneous mixture. As used herein, the term “mixture” refers to a sample of matter having more than one pure element or compound in association where the elements or compounds retain their properties within the sample. A mixture can be homogeneous (meaning uniform or identical throughout) or heterogeneous (meaning dissimilar or non-uniform throughout). As used herein, “high-energy efficiency” refers to an energy requirement per lb of H₂O₂ produced less than that often obtained with the anthraquinone (AO) process and the direct combination process in conjunction with macro-scale reactor technology. As used herein, “compressor” refers to mechanical means that take in a gas and increases the pressure of the gas by squeezing a volume of the gas into a smaller volume. As used herein, “operating pressure” refers to the pressure (i.e., force applied to a unit area of surface) at which the process of the present invention for the production of hydrogen peroxide from hydrogen and oxygen is performed.

In some embodiments, the process of the present invention for the production of hydrogen peroxide comprises reacting a combination of hydrogen and oxygen on a catalyst in a solvent, where the catalyst has one or more platinum group metals on an acidified support, then optionally, reacting the hydrogen, and oxygen on a catalyst in the presence of an acid dissolved in a solvent, further optionally, reacting the hydrogen, and oxygen on a catalyst in the presence of a halogen or halide dissolved in a solvent, while maintaining such reaction at a low pressure, and conducting such a reaction in a reactor system.

As used herein, the phrase “platinum group metal” refers to the six Group VIII elements of the periodic table, which include ruthenium, rhodium, palladium, osmium, iridium, and platinum. As used herein, the phrase “acidified support” refers to a solid superacid formed by acidification of a support with characteristics of an acid, which provides an anchor for the platinum group metal. As used herein, “halogen” refers to the Group VII elements of the periodic table, including fluorine (F), chlorine (Cl), bromine (Br), iodine (I), and astatine (At). As used herein, “halide” refers to a compound consisting of atoms of two different elements with one atom being a halogen, with the other atom being less electronegative than the halogen. As used herein, the term “reactor” or the phrase “reactor system” refers to a device or an assemblage of related devices for containing a reaction.

As used here, the phrase “low pressure” refers to pressures (i.e., a force applied to a unit area of surface) that are less than about 1,000 to about 2,000 psig operating pressure generally used in macroreactors for a direct combination process for producing hydrogen peroxide. For example, and without limitation, low pressure can include average reactor pressures between about 0 psig and about 500 psig (inclusive of about 0 psig and about 500 psig). In some embodiments, the low pressure of the process of the present invention for directly producing hydrogen peroxide is less than about 500 psig; less than about 450 psig; less than about 400 psig; less than about 350 psig; less than 300 psig; less than about 250 psig; less than about 200 psig; less than about 150 psig; less than about 100 psig; or less than about 50 psig. In some embodiments, the low pressure of the process of the present invention is from about 200 psig to about 300 psig (inclusive of about 200 psig and about 300 psig). In some embodiments, the low pressure of the process of the present invention is about 200 psig; about 210 psig; about 220 psig; about 230 psig; about 240 psig; about 250 psig; about 260 psig; about 270 psig; about 280 psig; about 290 psig; or about 300 psig.

As used herein, the various pressure units are understood to be related to each other by accepted conversion factors, such as, for example, the factors in the following table for converting from another pressure unit to Pascals, an often used pressure unit.

To convert from these pressure units to pascals (Pa) multiply by

| | |
|---|---|
| standard atmosphere (atm) | 101 325 |
| technical atmosphere (atm) | 98066.5 |
| bar (bar) | 100 000 |
| dyne per square centimeter (dyn/cm²) | 0.1 |
| gram-force per suare centimeter(gf/cm²) | 98.066 5 |
| kilogram-force per square centimeter (kgf/cm²) | 98 066.5 |
| kilopascal (kPa) | 1 000 |
| megapascal (MPa) | 1 000 000 |
| millibar (mbar) | 100 |
| pound force/square inch - PSI (lbf/in²) | 6 894.757 |
| Centimeter of mercury(0° C.) | 1 333.22 |
| standard centimeter of mercury (cmHg) | 1 333.224 |
| Millimeter of mercury (mmHg) | 133.322 4 |
| inch of mercury (32° C.) | 3 368.38 |
| conventional inch of mercury (inHg) | 3 386.389 |
| Centimeter of water (cmH₂O) | 98.066 5 |

In some embodiments, the process of the present invention to produce hydrogen peroxide involves a reactor system that includes a microreactor. As used herein, the term “microreactor” refers to a device or an assemblage of related devices that contains reaction channels in which at least one of the transverse dimensions is sub-millimeter. As used herein, the term “macroreactor” refers to a device or an assemblage of related devices that contains reaction channels in which the transverse dimensions are greater than about 1 millimeter. In some embodiments of such process, the reactor system includes a fixed bed reactor. As used herein, the term “fixed bed reactor” refers to a device or an assemblage of related devices in which the materials of the reaction, such as the reactants, solvent, and catalyst, remain stationary in the reactor.

In some embodiments, the process of the present invention for producing hydrogen peroxide involves conducting the reaction in the absence of an acid in a solvent and in the absence of a halogen or halide in a solvent; i.e., the solvent system (liquid stream) of the reaction contains neither an acid nor a halogen or halide. In some embodiments, the reacting of hydrogen and oxygen on a catalyst (i.e., the reaction of hydrogen and oxygen takes place physically on the catalyst) is conducted in the presence of an acid in the liquid solvent. Acids useful in the liquid solvent of the present invention include, for example, and without limitation, sulfuric acid (H₂SO₄), phosphoric acid (H₃PO₄), hydrochloric acid (HCl), hydrogen cyanide (HCN), nitric acid (HNO₃), hydrogen bromide (HBr) and hydrogen iodide (HI). In some embodiments, the acid in the solvent has a concentration of about 1 ppm to about 5×10⁴ ppm or about 10⁻³ wt % to about 5 wt % (1 weight percent equals 10,000 ppm or 10⁴ ppm). In some embodiments, no halogen or halide is present in the solvent; in some, a halogen or halide is present in the solvent. In some such embodiments, the acid includes sulfuric acid (H₂SO₄), phosphoric acid (H₃PO₄), hydrochloric acid (HCl), hydrogen cyanide (HCN), nitric acid (HNO₃), hydrogen bromide (HBr) or hydrogen iodide (HI). In some embodiments, the acid has a concentration from about 10⁻³ wt % to about 5 wt %.

In some embodiments, the process of the present invention for producing hydrogen peroxide comprises conducting the reaction in the presence of a halogen or halide in a solvent. In some such embodiments, no acid is present in the solvent; in some, an acid is present in the solvent. The halogen or halide promotes the catalyst, i.e., it accelerates or increases the activity and selectivity of the catalyst, and can be referred to as a catalyst promoter. In some embodiments, the halogen includes, e.g., bromine, chlorine, iodine, astatine or fluorine. In some embodiments, the halide includes a metal halide of the general formula, MeX, where Me is a metal and X is a halogen, such as NaBr, KBr, KI, KCl and the like. In some such embodiments, the metal halide is in an amount of about 1 ppm to about 50 ppm. In some embodiments, the metal halide is in an amount of about 10 ppm.

In some embodiments, the process of the present invention for producing hydrogen peroxide comprises conducting the reaction in the presence of both an acid (e.g., H₂SO₄, H₃PO₄, HCl, HCN, HNO₃, HBr or HI) and a halogen (e.g., Br) or halide, such as a metal halide (e.g., NaBr) in a solvent.

In some embodiments, the process to produce hydrogen peroxide of the present invention comprises substantially mixing the hydrogen and oxygen to produce a homogeneous gas mixture and contacting the gas mixture with a catalyst in a solvent; optionally, in the presence of an acid in the solvent; optionally, in the presence of a halogen or the halide in the solvent; and rapidly and effectively removing the heat of the reaction in a few seconds (e.g., at a rate that allows the use of water as a coolant). As used herein, the term “substantially” means to a large extent, e.g., where each substance is more interrelated to another substance than not, and where the mixture is homogeneous, i.e., no compositional variation from one sample of the mixture to another. In some embodiments, the reactor has a temperature of about 20° C. to about 60° C.; about 25° C. to about 55° C.; or about 40° C. to about 50° C.

In some embodiments of the process of the present invention for producing hydrogen peroxide, maintaining the low pressure further includes having an inlet pressure from about 3 psig to about 500 psig (inclusive of about 3 psig and about 500 psig) and an outlet pressure of about 0 psig to about 500 psig (inclusive of about 0 psig to about 500 psig).

In some embodiments, the process of the present invention to produce hydrogen peroxide comprises a solvent that is aqueous. As used herein, “aqueous” means water-based, of, relating to, containing, or resembling water. In some embodiments of the present invention, the solvent contains water. In some embodiments, the solvent is organic. As used herein, “organic” means of, relating to, or containing carbon, or belonging to the class of chemical compounds having a carbon basis. In some embodiments, the solvent contains methanol, ethanol, acetone, toluene, hexane, acetonitrile, 1-propanol, 2-propanol, acetic acid, isopropanol, triethanolamine, and the like.

In some embodiments, the process of the present invention for producing hydrogen peroxide comprises preparing the catalyst by a solution-gelation (sol-gel) process. The sol-gel process, which is a process often used for making glass and ceramic materials, involves the transition of a system from a liquid (the colloidal “sol”) into a solid (the “gel”). The sol comprises solid particles of a diameter of about a few hundred nanometers (nm), such as inorganic metal salts, suspended in a liquid phase. In a sol-gel process, the precursor often is subjected to a series of hydrolysis and polymerization reactions to form a colloidal suspension; the particles then condense into a new phase, the gel, in which a solid macromolecule is immersed in a solvent. By casting the gel into a mold, and with further drying and heat-treatment, often a dense ceramic or glass article with novel properties can be formed that could not be created by another method.

In some embodiments, the process of the present invention for preparing hydrogen peroxide involves a platinum group metal catalyst that includes palladium. In some embodiments, the platinum group metal of the catalyst includes a second platinum group metal, i.e., another Group VIII metal (e.g., iridium, osmium, platinum, rhodium and ruthenium), in addition to palladium. In some embodiments of such process, the support of the catalyst to which a co-acid is added is a silica compound, a zirconia compound, an alumina compound or a combination thereof, e.g., an alloy comprising two or more silica compounds, zirconia compounds or alumina compounds. The support of the present invention can have a variety of forms, such as a bed, a bead, a column, a granule, a pellet, a particulate, and a powder. In such embodiments, the support includes a silica compound; in some embodiments, a zirconia compound; in some embodiments, an alumina compound. In some such embodiments, the Group VIII metal(s) is from about 0.1 wt % to about 2 wt % of the catalyst; from about 0.1 wt % to about 6 wt % of the catalyst; or from about 0.1 wt % to about 5 wt % of the catalyst.

The catalyst of the present invention can be used in a variety of forms, e.g., as a particulate (about 10 μm to about 100 μm particle size) that is packed into the reactor vessel or as a thin-film coated on the internal walls of the reactor vessel. As used herein, the terms “packed” and “packing” mean to fill with an amount of catalyst that allows for the effective production of a predetermined amount of hydrogen peroxide and often require taking into consideration, e.g., the size of the reactor vessel, the particular catalyst, and the predetermined amount of hydrogen peroxide. As used herein, the phrase “reactor vessel” refers to an apparatus of a reactor system (as previously defined) where the reaction actually occurs. Thus, in some embodiments of the process of the present invention to produce hydrogen peroxide, the process further comprises packing the catalyst inside the reactor vessel. In some such embodiments, the amount of catalyst packed inside the reactor is from about 10 to 10³ gm catalyst/liter reactor volume. In some embodiments of the process of the present invention to produce hydrogen peroxide, the process further includes depositing the catalyst on the internal walls of the reactor vessel as a thin film. In some such embodiments, the deposited thin-film of catalyst has a thickness of about 1 μm to about 20 μm.

In some embodiments of the process of the present invention, as described above, the hydrogen and oxygen are in a proportion involving a flammable regime or explosive regime, or both. The hydrogen and oxygen are, therefore, of a ratio whereby the mixture in the reactor system, which includes the gases, and optionally, an acid and/or halogen or halide, in a solvent, can readily catch fire, explode or both in a macroreactor but not in the microreactor, as explained earlier, for example, where the hydrogen concentration is between about 5 volume percent (vol. %) and 96 vol % in hydrogen/oxygen mixture, and thus, the hydrogen to oxygen volume ratio is from about 5:95 to about 96:4. Such concentrations of hydrogen will enable a low operating pressure in the microreactor. In some embodiments, the hydrogen and oxygen are in a molar ratio of 1:1. Such a stoichiometric ratio of hydrogen to oxygen can provide a low operating pressure in the reactor. In further embodiments of such process, an effluent leaving the reactor is not explosive; i.e., the mixture exiting the reactor is outside the explosive range. The effluent can be diluted to reduce its explosiveness. In some embodiments, the effluent is diluted with nitrogen. In some embodiments, the nitrogen is in such an amount as to produce a non-flammable mixture (e.g., about 100 standard cubic centimeter per minute (sccm)).

In some embodiments of the process of the present invention for producing hydrogen peroxide, the hydrogen is a mixture of hydrogen and air. In some such embodiments, the mixture contains hydrogen in air in proportions, such as, e.g., about 1% to about 10% hydrogen in air; about 2% to about 4% hydrogen in air; or about 2.89% hydrogen in air. In some embodiments of such process, the hydrogen includes pure hydrogen. “Pure,” as used herein, means substantially (principally) free of extraneous elements, i.e., containing about 98.0% to about 100.0% of the element of interest. In some embodiments of such process, the oxygen includes air. In some embodiments, the oxygen includes pure oxygen.

In some embodiments of the process of the present invention for producing hydrogen peroxide, the so-called Taylor flow regime is obtained in the microreactor. The expression “Taylor flow regime,” also known as “slug flow regime,” refers to a flow pattern where gas bubbles are separated from each other by liquid plugs in a channel.

The present invention also provides for a sol-gel-produced catalyst having one or more platinum group metals and an acidified support. Such catalyst can be used in the process for producing hydrogen peroxide as previously described. In some embodiments of the catalyst, the platinum group metal comprises palladium. In some embodiments, the catalyst further comprises a second platinum group metal in addition to palladium. In some embodiments, the catalyst further comprises a second platinum group metal in addition to a first platinum group metal that is not palladium. In some embodiments, the second platinum group metal is selected from iridium, osmium, platinum, rhodium, palladium and ruthenium. In some embodiments of the catalyst, the platinum group metal(s) encompasses from about 0.1 wt % to about 2 wt % of the catalyst; from about 0.1 wt % to about 6 wt % of the catalyst; or from about 0.1 wt % to about 5 wt % of the catalyst. In some embodiments of the catalyst, the acidified support comprises a silica compound, a zirconia compound, an alumina compound, or a combination thereof, e.g., an alloy comprising two or more silica compounds, zirconia compounds or alumina compounds. In some such embodiments, the acidified support comprises a silica compound; in some embodiments, a zirconia compound; in some embodiments, an alumina. In some such embodiments, the acidified support includes a silica such as, e.g., a sulfated silica. The acidified support of the present invention can have a variety of forms such as a column, a bed, a bead, a granule, a particulate, a pellet, and a powder.

The present invention further provides a process for preparing the catalyst of the invention. In some embodiments of such process, the process comprises the steps of:
(a) preparing a gel of an acidified support by a sol-gel process that comprises:
   (i) forming a solution (sol) of a precursor material of the support and the co-acid,
   (ii) casting the sol into a mold to form a gel,
   (iii) adding a platinum group metal during gelation, i.e., at step (ii), and
   (iv) optionally, adding one or more additional platinum group metals during gelation, then
(b) drying the gel of (a),
(c) calcining the dried gel of (b) and
(d) reducing the calcined gel of (c).
   The steps (and sub-steps) of the process often are performed in the order presented, though each step necessarily does not have to be performed in the order presented.

As used herein, the terms “calcined,” “calcination” and “calcining” are used interchangeably to refer to the conversion of the physical or chemical properties of a substance by the application of heat. As used herein, the terms “reducing,” “reduction” and “reduced” interchangeably refer to the transformation of the gel formed by the sol-gel process of the present invention into a material having a smaller porosity and increased mechanical properties when compared to before the transformation in a an atmosphere having little or no oxygen and often high in hydrogen, such as an atmosphere of hydrogen rich gas; the transformation can include, e.g., densification and crystallization of the material. Further, chemically speaking the terms “reducing,” “reduction” and “reduced” interchangeably refer to the process in which electrons are added to an atom or ion (as by removing oxygen or adding hydrogen).

The precursor material of the support is a material that can be converted to the support material during the sol-gel process. Some non-limiting examples of precursor materials include silicone, siloxane, silazane, silane, tetraethoxysilane (TEOS), Zr(OPr)₄, Zr(OH)₄, ZrOCl₂.8H₂O, Zr(NO₃)₄, aluminum oxide, aluminum nitrate, aluminum ethoxide, aluminum iso-propoxide, and aluminum sec-butoxide. Some non-limiting examples of the co-acid include sulfuric acid (H₂SO₄), phosphoric acid (H₃PO₄), hydrochloric acid (HCl), hydrogen cyanide (HCN), nitric acid (HNO₃), hydrogen bromide (HBr), hydrogen iodide (HI). A non-limiting example of an acidifying agent is ammonium sulfate ((NH₄)₂SO₄).

In some embodiments of the process for preparing the catalyst, drying of the gel occurs at a temperature from about 100° C. to about 200° C.; from about 110° C. to about 150° C.; or about 110° C. In some embodiments of such process, the calcining of the dried gel occurs at a temperature from about 300° C. to about 500° C.; in some embodiments, about 300° C. In some embodiments of such process, the reduction of the calcined gel occurs at a temperature from about 300° C. to about 500°; in some embodiments, about 400° C.

Catalyst Preparation Method

The catalyst preparation method of the present invention is illustrated by, but not limited to, the following procedure. Preparation of the palladium on acidified silica support catalyst by a sol-gel method (i.e., process) involves at least five major steps: (1) preparation of acidified silica by a sol-gel method, (2) addition of the active Pd metal in the form of PdCl₂ to the silica sol, (3) drying, (4) calcination and (5) reduction.

In preparing the acidified silica by a sol-gel method, tetraethoxysilane (TEOS), ethanol and water (e.g., about 1:3:10 molar ratio) are mixed thoroughly for 2 hours at room temperature. Hydrochloric acid is added to the solution in order to catalyze the reaction between TEOS and water and render the cloudy solution clear. The co-acid for the acidification of the support is added. In some embodiments, a halogen or halide is added. In such embodiments of the process for making a sol-gel catalyst of the present invention, the halogen or halide acts like a co-acid (rather than as a halogen). In some embodiments of the process of preparing a sol-gel catalyst of the present invention, the molar ratios of TEOS to the hydrochloric acid and the co-acid are about 1:0.53:0.88. In some embodiments, the molar ratio of co-acid to TEOS in the sol-gel method is about 0.05 to about 5. In some embodiments, the molar ratio of water to TEOS in the sol-gel method is about 1 to about 50. In some embodiments, the molar ratio of ethanol to TEOS in the sol-gel method is about 0.1 to about 10. In some embodiments, the molar ratio of hydrochloric acid to TEOS in the sol-gel method is about 0.01 to about 10.

Then, a hydrolysis reaction takes place between water and TEOS by replacing the alkoxide groups in TEOS with hydroxyl groups. Since TEOS and water are immiscible, ethanol is used to enable the mixture of the two chemicals. During the process of preparing supported metal catalysts, the precursor of the active metal is anchored to the support by a hydroxyl (—OH) group on the support, which, without being limited by theory, forms a chemical bond between the support and the metal. This strong bond is unlike the association between the molecules of the active metal and the support found with wet impregnated catalysts.

In the case of the sol-gel method of the present invention, the co-acid is added to the support precursor (e.g., tetraethyloxysilane (TEOS)) at the preparation step, which enables the incorporation of the acidic functionality within the support framework in the form of a chemical bond. Without being bound to any particular theory, the chemical bond that anchors a co-acid to a support network can be, for example, a sulfated siloxy bond (—Si—O—SO₂), such as:

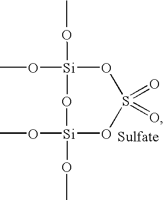

as suggested by Morrow, B. A, et al., J Cat., 107: 232-239(1987). After drying and calcining, it appears that this kind of textual structure is retained partly in the framework of the catalyst, resulting in large pore size and large pore volume.

A condensation reaction occurs where, without being bound to any particular theory, molecules of the aforementioned reactant become covalently bonded to one another by the concurrent loss of a small molecule, often water, methanol, or a type of hydrogen halide such as HCl, resulting in the acidified silica gel comprising a network such as: 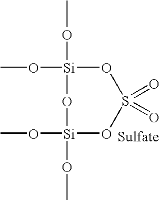
(see, e.g., Morrow, B. A, et al., supra).

In most cases, condensation commences before hydrolysis is complete. However, addition of catalysts (e.g., an acid or a base) can force the completion of hydrolysis before condensation begins. In order to obtain about 2% Pd on acidified SiO₂ support, about 0.05 g of PdCl₂ for every 5 ml of TEOS is added to the above sol. Palladium (II) chloride (PdCl₂) is added during the gelation step producing a strong interaction between the precursor and the —OH surface group. The entire mixture is stirred thoroughly overnight at room temperature.

The wet gel obtained is dried in order to make powdered catalysts. During drying, only free water and solvents (e.g., ethanol) are removed from the gel. Therefore, a temperature of about 110° C. can be used for drying to get rid of the free water and solvent from the gel. Removal of water and solvent or organics trapped in the tiny pores requires a much higher temperature (about 300° C. to about 500° C.). Hence, drying should be followed by calcination at a higher temperature. The calcination step is very important as a number of structural and morphological changes take place, allowing the introduction of different catalytic phases dispersed in the silica matrix, depending upon the temperature used for calcination. During calcination, PdCl₂ decomposes into Pd or PdO (depending upon the temperature) and Cl₂. The reducibility of Pd is determined at this stage. That is, the temperature, time and the ambient conditions can be changed to vary the reducibility of Pd. Usually there is a tradeoff between temperature used for calcination and activity. Increase in temperature may lead to the possibility of the reaction between Pd and the silica support leading to the formation of Pd-silicate. A Pd-silica interaction can drastically lower the activity of the catalyst. Hence, a temperature between about 300° C. and about 500° C. is best suited for calcination.

The calcination step drives off Cl as Cl₂ from the gel, and determines the reducibility of Pd²⁺ in the reduction stage. If calcination of the gel is done in air at a higher temperature, there is a greater possibility of producing more PdO (from Pd²⁺) than Pd⁰. Therefore, reduction of PdO or Pd²⁺ is required to produce metallic Pd. Hence, the final step of reduction with hydrogen at a temperature of about 400° C. ensures complete conversion of PdO to Pd.

Process for Hydrogen Peroxide Production

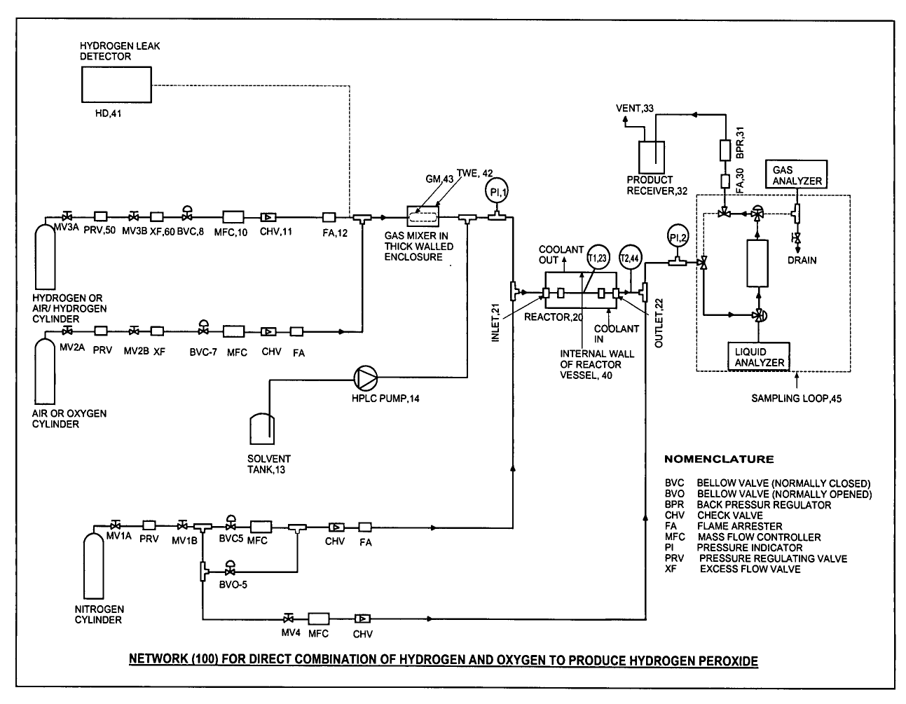

The process for the production of hydrogen peroxide according to the present invention is illustrated by, but not limited to, the following experimental procedure, FIG. 1 and Examples. Thus, the present invention further provides a network (100) for carrying out the process of the present invention. The network (100) of the present invention comprises an assembly of apparatus and devices used in the production of hydrogen peroxide according to the present invention. In some embodiments, the network (100) of the present invention comprises a check valve (CHV, 11), a flame arrester (FA, 12), an excess flow value (XF, 60), and a hydrogen detector (HD, 41). In some embodiments, the network further comprises a back pressure regulator (BPR, 31), a mass flow controller (MFC, 10), a pressure indicator (PI, 1 and 2), a pressure regulating value (PRV, 50), and a thick-walled (approximately 1 inch thickness) metallic enclosure (TWE, 42) for a gas mixer (GM, 43). In some embodiments, the network further comprises a microreactor.

The network of the present invention allows for better control of the process of the present invention than with other hydrogen peroxide production networks. For example, and without limitation, in the present invention, the flame arrester (FA, 12) of the network can prevent a flame generated by a flammable mixture, such as hydrogen-oxygen or hydrogen-air, that is downstream from the flame arrester from propagating upstream; the check value (CHV, 11) of the network can allow the flow in one direction only, thereby, preventing flow from another line, such as the liquid mixture of the process of the present invention from flowing back into the supply lines of the gas streams where the liquid mixture could damage devices of the network, such as flow controllers, bellow values and the like, or cause such devices to malfunction; the hydrogen detector (HD, 41) of the network can identify a hydrogen leak in the network and can be situated so as to notify of such a leak and/or automatically switch off the power to the network thereby preventing the flow of hydrogen and oxygen through the bellow values of the network; and the excess flow value (XF, 60) can shut off the flow of gas from the gas source (e.g., a gas cylinder) when there is a gas leak downstream of the gas source in excess of the flow rate rating of the excess flow value. Also, the thick-walled metallic enclosure (TWE, 42) for the gas mixer (GM, 43) can protect the network and external environment from an unfortunate explosion. Further, the dilution of reactor gas effluent by nitrogen allows the production of a hydrogen-oxygen or a hydrogen-air gas mixture with a composition outside their explosive and flammable regions. Therefore, the level of control achievable with the network of the present invention allows for a safe means for producing hydrogen peroxide, according to the present invention.

As illustrated in FIG. 1, on a larger scale, the single microreactor assembly used can involve an appropriate increase in the number of micro-scale elements operating in parallel achieved by stacking/bundling up a plurality of bundled/stacked microchannel plates with multi-channels. The feed gas streams can be an air/hydrogen mixture or pure hydrogen and pure oxygen.

In some embodiments, the network of the present invention can be used for the process of the present invention. In some such embodiments, the concentration of hydrogen in the premixed hydrogen-air mixture tank was about 2.89%. The gas stream was then mixed in a tee (i.e., a T-junction, which is a point where one means of delivery (e.g., tubes, pipes) meets another without crossing it, thus, forming a “T” between them) with the liquid (13) stream, pumped by a high performance/pressure liquid chromatography (HPLC, 14) pump.

The reactor (20) used was made of stainless steel (SS316L) with an outer diameter of about 1.5875 mm and inner diameter of about 0.775 mm (about 775 μm). The length of the reactor was about 6 cm. The reactor was either packed with the catalyst in particulate form or the catalyst was deposited on the reactor walls as a thin film. Two micron (2 μm) frits (meaning a filtering/sieving porous structure) were installed at the inlet (21) and outlet (22) of the reactor (20) for the packed bed catalyst. The reactor (20) was placed in the line by using PEEK® (polyetheretherketone) unions and ferrules. “Unions” are fittings for connecting two pieces of tubing of the same or different outer diameter, while “ferrules” are one of the components of a compression fitting, the conical piece of metal or plastic that compresses onto a tube as it is forced into a tapered seat. The unions and ferrules are designed to push the two pieces of tubing towards each other as the union is tightened, ensuring there is no gap between the ends of the tubing.

A constant temperature (TI, 23) water bath was used to heat the reactor to the desired temperature. The temperature of the reactor just before the exit (T2, 44) was measured by using a chromel-alumel thermocouple soldered on the reactor outer wall. The inlet (21) and outlet (22) pressures of the reactor were measured using an OMEGA DP-24E process meter (Omega Engineering, Inc., Stamford, Conn.) and PX 541 series pressure transducers (Dynisco Instruments & Polymer Test, Franklin, Mass.). From the reactor (20), the reaction mixture passed through a flame arrester (FA, 30) and then through a back pressure regulator (BPR, 31). The back pressure regulator (BPR, 31) was used to obtain the desired pressure during an experimental run. From the back pressure regulator (BPR, 31), the mixture was passed to a product receiver (32) where the liquid is collected for the hydrogen peroxide (H₂O₂) measurement and the gas phase is vented to the atmosphere (33).

Before making an experimental run, the network (100) was purged of any impurities by passing nitrogen gas and then the solvent through an empty tube in place of the reactor (20). After purging, the reactor (20) is placed in line in the network (see e.g., FIG. 1). A reaction run was made by first pumping the liquid through the network at a flow rate of about 2.0 ml/min. to about 2.5 ml/min. A few minutes after the liquid flows through the product receiver (32), the backpressure regulator (BPR, 31) was closed to obtain the reactor outlet pressure (PI2) just above the desired reactor outlet pressure (e.g., about 0 to about 500 psig). The liquid flow rate was then adjusted to the desired value such as, e.g., about 0.05 ml/min, and the backpressure regulator (BPR, 31) was adjusted to maintain the pressure in the system. The premixed hydrogen-air mixture then was passed through the assembly by opening the air actuated bellow valve (BVC, 8). The flow rate of the air-hydrogen mixture was controlled using the mass flow controller (MFC, 10). The reactor outlet temperature was maintained at the desired value by controlling the temperature of the water bath (T1, 23). The effluent is collected from the sampling loop (45) for hydrogen peroxide measurements. Measurement of the hydrogen peroxide concentration initially was done using the CHEMetrics, Inc. (Calverton, Va.) ferric thiocyanate colorimetric method by visual (i.e., by eye) color comparison. Some of the results were validated with a well-known analytical titration method using KMnO₄.

Unless defined otherwise, all technical and scientific terms used herein have the same meaning as commonly understood by one of ordinary skill in the art to which this invention belongs. Although any methods and materials similar or equivalent to those described herein also can be used in the practice or testing of the present invention, the preferred methods and materials are now described. All publications mentioned herein are incorporated herein by reference to disclose and described the methods and/or materials in connection with which the publications are cited.

It must be noted that, as used herein and in the appended claims, the singular forms “a”, “and”, and “the” include plural references unless the context clearly dictates otherwise. All technical and scientific terms used herein have the same meaning when used.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

### EXAMPLES

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g., amounts, temperature, etc.), but some experimental errors and deviations should be accounted for. Unless indicated otherwise, parts are parts by weight, molecular weight is average molecular weight, and temperature is in degrees Centigrade.

### Example 1

In accordance with the experimental set-up described above, 33.7 mg of Pd/SiO₂ catalyst was packed into a microreactor. Ten (10) sccm of premixed 2.89 vol % H₂-air mixture and 0.05 ml/min. deionized water containing no sulfuric acid (0% H₂SO₄) and 10 ppm of NaBr were passed into the microreactor maintained at 49° C. at an average inlet pressure of 312 psig and an average outlet pressure of 304 psig. The concentration of hydrogen peroxide product sampled and analyzed by titration using KMnO₄ was 762 ppm (approximately 0.076 wt %).

### Example 2

In accordance with the experimental set-up described above, 30 mg of Pd/SiO₂ catalyst was packed into a microreactor. Ten (10) sccm of premixed 2.89 wt % H₂-air mixture and 0.05 ml/min. deionized water containing 1 wt % H₂SO₄ and 10 ppm of NaBr were passed into the microreactor maintained at 46° C. at an average inlet pressure of 315 psig and an average outlet pressure of 309 psig. The concentration of hydrogen peroxide product sampled and analyzed by titration using KMnO₄ was 1127 ppm (0.11 wt %).

### Example 3

In accordance with the experimental set-up described above, 8 mg of Johnson Matthey, Inc.'s (Malvern, N.J.) commercially available 5 wt % Pd on carbon support catalyst was packed into a microreactor. Ten (10) sccm of premixed 2.89 vol % H₂-air mixture and 0.05 ml/min. deionized water containing 1 wt % H2SO4 and 10 ppm of NaBr were passed into the microreactor maintained at 43° C. at an average inlet pressure of 367 psig and an average outlet pressure of 300 psig. The concentration of hydrogen peroxide product sampled and analyzed using CHEMetrics, Inc.'s ferric thiocyanate colorimetric method by visual color comparison was 600 ppm (0.06 wt %).

### Example 4

In accordance with the experimental set-up described above, 16.7 mg of 1.5 wt % Pd/Al₂O₃ was packed into a microreactor. Ten (10) sccm of premixed 2.89 vol % H₂-air mixture and 0.05 ml/min. methanol containing 10 ppm of NaBr were passed into the microreactor maintained at 24° C. at an average inlet pressure of 250 psig and an average outlet pressure of 90 psig. The concentration of hydrogen peroxide product sampled and analyzed using CHEMetrics, Inc.'s ferric thiocyanate colorimetric method by visual color comparison was 15 ppm (0.002 wt %).

### Example 5

In accordance with the experimental set-up described above, 26 mg of Pd/SiO₂ catalyst was packed into a microreactor. Twenty (20) sccm of air and 4.2 sccm of H₂, representing a mixture with a 1:1 molar ratio of H₂:O₂, with 0.05 m/min. deionized water containing 1 wt % H₂SO₄ and 10 ppm of NaBr were passed into the microreactor maintained at 41° C. at an average inlet pressure of 120 psig and an average outlet pressure of 106 psig. The effluent from the reactor was diluted with 100 sccm of N₂. The concentration of hydrogen peroxide product sampled and analyzed by titration using KMnO₄ was on the average of 300 ppm.

### Example 6

In accordance with the experimental set-up described above, 30.7 mg of Pd/SiO₂ catalyst was packed into a microreactor. Ten (10) sccm of premixed 2.89 vol % H₂-air mixture and 0.05 ml/min. deionized water containing 1 wt % H₂SO₄ and 10 ppm of NaBr were passed into the microreactor maintained at 42° C. at an average inlet pressure of 330 psig and an average outlet pressure of 315 psig. The concentration of hydrogen peroxide product sampled and analyzed by titration using KMnO₄ was 2350 ppm (0.24 wt %).

### Example 7

In accordance with the experimental set-up described above, a capillary reactor made of stainless steel 316L with an inside diameter of 800 μm and a length of 60 mm was coated with a thin-film layer of Pd/Al₂O₃ catalyst using the sol-gel technique of the present invention. Twenty (20) sccm of premixed 2.89 vol % H₂-air mixture and 0.05 ml/min. methanol containing 10 ppm of NaBr were passed into the microreactor maintained at 44° C. at an average inlet pressure of 312 psig and an average outlet pressure of 312 psig (approximately zero pressure drop). The concentration of hydrogen peroxide product sampled and analyzed using CHEMetrics, Inc.'s ferric thiocyanate colorimetric method by visual color comparison was 90 ppm (0.01 wt %).

### Example 8

In accordance with the experimental set-up described above, 30 mg of Pd/SiO₂ catalyst was packed into the microreactor. Twenty (20) sccm of air and 4.2 sccm of H₂, representing a mixture with a 1:1 molar ratio of H₂:O₂, with 0.05 ml/min. methanol containing 10 ppm of NaBr and no sulfuric acid (0 wt % H₂SO₄) were passed into the microreactor maintained at 42° C. at an average inlet pressure of 215 psig and an average outlet pressure of 205 psig. The effluent from the reactor was diluted with 100 sccm of N₂. The concentration of hydrogen product sampled and analyzed by titration using KMnO₄ was on the average 450 ppm.

### Example 9

In accordance with the experimental set-up described above, a 15.2 mg of sulfated Pd/SiO₂ catalyst prepared by following the catalyst preparation procedure described above, but after dissolving the PdCl₂ in HCl solution (serving as catalyst for hydrolysis reaction),.sulfuric acid, the co-acid, was added. (The ranges for useful amounts of HCl, sulfuric acid and other reagents s are provided in the catalyst preparation procedure described above.) The sulfated Pd/SiO₂ was packed into a microreactor of about 9 cm long. A 20 sccm of air and 2 sccm of H₂ with 0.05 ml/min. deionized water containing 1 wt % H₂SO₄ and 10 ppm of NaBr were passed into the microreactor maintained at 55° C. at an average inlet pressure of 330 psig and an average outlet pressure of 320 psig. The concentration of hydrogen product sampled and analyzed by titration using KMnO₄ was 11000 ppm (1.1 wt %).

While the present invention has been described with respect to what are some embodiments of the invention, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A process for the production of hydrogen peroxide by a direct combination of hydrogen and oxygen, the process comprising the steps:
a. reacting a combination of hydrogen-containing gas stream and oxygen-containing gas stream on a catalyst in the presence of a solvent;
b. maintaining (a) under low pressure; and
c. conducting (a)-(b) in a microreactor system.

2. The process according to claim 1, wherein the catalyst comprises at least one platinum group metal on an acidified support.

3. The process according to claim 2, wherein the reacting step (a) occurs in the presence of an acid in the solvent.

4. The process according to claim 2, wherein the reacting step (a) occurs in the presence of a halogen or halide in the solvent.

5. The process according to claim 1, wherein the reactor system comprises a fixed bed reactor.

6. The process according to claim 1, wherein the reacting step (a) is conducted in the absence of an acid and in the presence of a halogen or a halide in the solvent.

7. The process according to claim 1, wherein the reacting step (a) is conducted in the presence of an acid in the solvent.

8. The process according to claim 1, wherein the reacting step (a) is conducted in the presence of a halogen or a halide in the solvent.

9. The process according to claim 8, wherein the reacting step (a) is further conducted in the presence of an acid in the solvent.

10. The process according to claim 8, wherein the acid comprises from about 1 ppm to about 5×10⁴ ppm of the solvent.

11. The process according to claim 10, wherein the acid comprises H₂SO₄, H₃PO₄, HCl, HCN, HNO₃, HBr or HI.

12. The process according to claim 8, wherein the halogen is Br, Cl, I, F or At.

13. The process according to claim 9, wherein the halogen is Br, Cl, I, F or At.

14. The process according to claim 12, wherein the halogen is Br.

15. The process according to claim 13, wherein the halogen is Br.

16. The process according to claim 8, wherein the halide comprises a metal halide.

17. The process according to claim 16, wherein the metal halide is NaBr, KBr, KCl or KI.

18. The process according to claim 16, wherein the metal halide comprises an amount from about 1 ppm to about 50 ppm.

19. The process according to claim 17, wherein the amount of metal halide comprises about 10 ppm.

20. The process according to claim 9, wherein the halide comprises a metal halide.

21. The process according to claim 20, wherein the metal halide is NaBr, KBr, KCl or KI.

22. The process according to claim 20, wherein the metal halide comprises an amount from about 1 ppm to about 50 ppm.

23. The process according to claim 22, wherein the amount of metal halide comprises about 10 ppm.

24. The process according to claim 1, wherein the reactor system has a temperature from about 20° C. to about 60° C.

25. The process according to claim 19, wherein the temperature is from about 25° C. to about 55° C.

26. The process according to claim 20, wherein the temperature is from about 40° C. to about 50° C.

27. The process according to claim 1, wherein step (b) further comprises having an inlet pressure from about 50 psig to about 500 psig and an outlet pressure of about 0 psig to about 500 psi.

28. The process according to claim 1, wherein the solvent is aqueous.

29. The process according to claim 28, wherein the solvent comprises water.

30. The process according to claim 1, wherein the solvent is organic.

31. The process according to claim 30, wherein the solvent comprises methanol, ethanol, acetone, toluene, hexane, acetonitrile, 1-propanol, 2-propanol, acetic acid, isopropanol, triethanolamine, or a combination thereof.

32. The process according to claim 1, wherein the catalyst in step (a) is prepared by a sol-gel process.

33. The process according to claim 1, wherein the platinum group metal of the catalyst in step (a) comprises palladium.

34. The process according to claim 1, wherein the catalyst in step (a) further comprises a second platinum group metal.

35. The process according to claim 34, wherein the second platinum group metal comprises iridium, osmium, platinum, rhodium or ruthenium.

36. The process according to claim 2, wherein the acidified support of the catalyst comprises a silica compound, a zirconia compound, or an alumina compound.

37. The process according to claim 36, wherein the acidified support comprises a silica compound.

38. The process according to claim 37, wherein the acidified support is acidified by a co-acid.

39. The process according to claim 38, wherein the co-acid comprises sulfuric acid, hydrochloric acid, hydrogen cyanide, phosphoric acid, hydrogen bromide, hydrogen fluoride, nitric acid or hydrogen iodide.

40. The process according to claim 37, wherein the acidified support is acidified by an acidifying agent.

41. The process according to claim 40, wherein the acidifying agent comprises ammonium sulfate.

42. The process according to claim 1, wherein the metal(s) comprises from about 0.1 wt % to about 2 wt % of the catalyst.

43. The process according to claim 42, wherein the metal(s) comprises from about 0.1 wt % to about 6 wt % of the catalyst.

44. The process according to claim 43, wherein the metal(s) comprises from about 0.1 wt % to about 5 wt % of the catalyst.

45. The process according to claim 1 further comprising the step of packing the catalyst inside the reactor system.

46. The process according to claim 45, wherein the catalyst is packed inside the reactor in an amount comprising from about 10 gm/liter reactor volume to about 1000 gm/liter reactor volume.

47. The process according to claim 1 further comprising the step of depositing the catalyst onto an internal wall of the reactor as a thin-film.

48. The process according to claim 47, wherein the thin-film of catalyst comprises a thickness of about 1 μm to about 20 μm.

49. The process according to claim 1, wherein the hydrogen and oxygen are in a proportion that comprises a flammable regime, explosive regime or both.

50. The process according to claim 49, wherein the proportion of hydrogen and oxygen comprises from about 5 vol % to about 96 vol % hydrogen in oxygen or about 5 vol % to about 74 vol % hydrogen in air.

51. The process according to claim 1, wherein the hydrogen and oxygen are in a proportion comprising about a 1:1 molar ratio.

52. The process according to claim 1, wherein an effluent leaving the reactor is non-explosive.

53. The process according to claim 52, wherein the effluent is diluted with nitrogen.

54. The process according to claim 53, wherein the nitrogen is in an amount of about 100 sccm.

55. The process according to claim 1, wherein the hydrogen comprises a hydrogen and air mixture.

56. The process according to claim 55, wherein the mixture comprises about 1 vol % to about 10 vol % hydrogen in air.

57. The process according to claim 56, wherein the mixture comprises about 2 vol % to about 4 vol % hydrogen in air.

58. The process according to claim 57, wherein the mixture comprises about 2.89 vol % hydrogen in air.

59. The process according to claim 1, wherein the hydrogen comprises pure molecular hydrogen.

60. The process according to claim 1, wherein the oxygen comprises air.

61. The process according to claim 1, wherein the oxygen comprises pure molecular oxygen.

62. The process according to claim 1, wherein the reacting in step (a) is continuous.

63. A sol-gel-produced catalyst comprising one or more platinum group metals and an acidified support.

64. The catalyst according to claim 63, wherein the platinum group metal comprises palladium.

65. The catalyst according to claim 64, further comprising a second platinum group metal.

66. The catalyst according to claim 65, wherein the second platinum group metal comprises iridium, osmium, platinum, rhodium or ruthenium.

67. The catalyst according to claim 66, wherein the acidified support comprises a silica compound, a zirconia compound, or an alumina compound.

68. The catalyst according to claim 64, wherein the acidified support comprises a silica compound.

69. The catalyst according to claim 68, wherein the acidified support is acidified by a co-acid.

70. The catalyst according to claim 69, wherein the co-acid comprises sulfuric acid, hydrochloric acid, hydrogen cyanide, phosphoric acid, hydrogen bromide, hydrogen fluoride, nitric acid or hydrogen iodide.

71. The catalyst according to claim 68, wherein the acidified support is acidified by an acidifying agent.

72. The catalyst according to claim 71, wherein the acidifying agent comprises ammonium sulfate.

73. The catalyst according to claim 63, wherein the metal(s) comprises from about 0.1 wt % to about 2 wt % of the catalyst.

74. The catalyst according to claim 73, wherein the metal(s) comprises from about 0.1 wt % to about 6 wt % of the catalyst.

75. The catalyst according to claim 74, wherein the metal(s) comprises from about 0.1 wt % to about 5 wt % of the catalyst.

76. The catalyst according to claim 63, wherein the catalyst is used for production of hydrogen peroxide in a macroreactor.

77. The catalyst according to claim 63, wherein the catalyst is used for production of hydrogen peroxide in a microreactor.

78. A process for preparing a catalyst, the process comprising the steps of:
a. preparing a gel of an acidified support by a sol-gel process that comprises the steps of:
i. forming a sol comprising a precursor material of the support and a co-acid;
ii. casting the sol into a mold to form a gel;
iii. adding a platinum group metal at the gelation step of (ii); and
iv. optionally, adding one or more additional platinum group metals; and
b. drying the gel of (a);
c. calcining the dried gel of (b); and
d. reducing the calcined gel of (c).

79. The process according to claim 78, wherein the drying of step (b) occurs at a temperature from about 100° C. to about 200° C.

80. The process according to claim 79, wherein the drying of step (b) occurs at a temperature from about 110° C. to about 150° C.

81. The process according to claim 80, wherein the drying of step (b) occurs at a temperature of about 110° C.

82. The process according to claim 78, wherein the calcining of step (c) occurs at a temperature from about 300° C. to about 500° C.

83. The process according to claim 82, wherein the calcining of step (c) occurs at a temperature of about 300° C.

84. The process according to claim 78, wherein the reducing of step (d) occurs at a temperature from about 300° C. to about 500° C.

85. The process according to claim 84, wherein reducing of step (d) occurs at a temperature of about 400° C.

86. The process according to claim 78, wherein the precursor material of the support and the co-acid have a molar ratio of about 0.01 to about 10.

87. The process according to claim 86, wherein the precursor material of the support and the co-acid have a molar ratio of about 0.05 to about 5.

88. The process according to claim 86, wherein the precursor material of the support is tetraethyoxysilane.

89. The process according to claim 88, wherein the co-acid comprises sulfuric acid, hydrochloric acid, hydrogen cyanide, phosphoric acid, hydrogen bromide, hydrogen fluoride, nitric acid or hydrogen iodide.

90. The process according to claim 78, wherein step (a) comprises a solvent.

91. The process according to claim 90, wherein the solvent comprises ethanol.

92. The process according to claim 91, wherein the precursor material of the support and the ethanol have a molar ratio of about 0.1 to about 10.

93. A network for use in the production of hydrogen peroxide according to claim 1.

94. The network according to claim 93, wherein the network comprises a check valve, a flame arrester, an excess flow value and a hydrogen detector.

95. The network according to claim 94 further comprising a back pressure regulator, a mass flow controller, a pressure indicator, a pressure regulating value, and a thick-walled metallic enclosure for a gas mixer.

96. A process for making hydrogen peroxide, comprising: flowing a process feed stream and a staged addition feed stream in contact with each other in a process microchannel to form a reactant mixture comprising O₂ and H₂, and contacting a catalyst with the reactant mixture in the process microchannel to convert the reactant mixture to a product comprising hydrogen peroxide; transferring heat from the process microchannel to a heat exchanger; and removing the product from the process micro channel.
